(19) United States
(12) Patent Application Publication
(10) Pub. No.: US 2026/0004256 A1
(43) Pub. Date: Jan. 1, 2026

(54) ASSET HISTORY BASED SERVICE PREDICTIONS

(71) Applicant: Salesforce, Inc., San Francisco, CA (US)

(72) Inventors: Vinitha Ravichandran, Bellevue, WA (US); Vinay Bayya, Bellevue, WA (US); Yung Chen, San Francisco, CA (US); Carla Ferreira, Bellevue, WA (US)

(21) Appl. No.: 18/759,748

(22) Filed: Jun. 28, 2024

(51) Int. Cl. G06Q 10/20; G06F 16/25; G06Q 10/04

(52) U.S. Cl. CPC G06Q 10/20; G06F 16/25; G06Q 10/04

(57) ABSTRACT

Methods, systems, apparatuses, and computer program products are described. A data processing system may ingest asset service action history data from data sources of different data organization models via clicks from a user, generate at least an asset service action training data set from the ingested data, and train an asset management model to predict future asset service actions using the asset service action training data set. The different data organization models may include data objects including cases, work orders, asset identifiers, and products. The data processing system may transform the ingested asset history into the asset service action training data set according to a configurable unified data model. The future asset service action predictions may be based on a binary classification system, and may indicate a likelihood of performing a second asset service action type on an asset type based on an inputted first asset service action type.

### FIELD OF TECHNOLOGY

The present disclosure relates generally to database systems and data processing, and more specifically to asset history based service predictions.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A user may utilize one or more assets of different asset types for productivity (e.g., appliances, tools, vehicles, machines, processors, computers etc.). In some cases, different asset types may malfunction (e.g., break, have issues, need replacement parts) at different times during lifecycles of the asset types, which may cause the user to perform asset service actions on the assets. In some cases, handling asset service actions separately for an asset type may be costly to the user, and may increase downtime of the asset.

### BRIEF DESCRIPTION OF THE DRAWINGS

FIG. 1 illustrates an example of a data processing system that supports asset history based service predictions in accordance with aspects of the present disclosure.

FIG. 2 shows an example of a data architecture diagram that supports asset history based service predictions in accordance with aspects of the present disclosure.

FIG. 3 shows an example of a data architecture diagram that supports asset history based service predictions in accordance with aspects of the present disclosure.

FIG. 4 shows an example of a binary classification diagram that supports asset history based service predictions in accordance with aspects of the present disclosure.

FIG. 5 shows an example of a process flow that supports asset history based service predictions in accordance with aspects of the present disclosure.

FIG. 6 shows a block diagram of an apparatus that supports asset history based service predictions in accordance with aspects of the present disclosure.

FIG. 7 shows a block diagram of an asset service action prediction manager that supports asset history based service predictions in accordance with aspects of the present disclosure.

FIG. 8 shows a diagram of a system including a device that supports asset history based service predictions in accordance with aspects of the present disclosure.

FIGs. 9 through 11 show flowcharts illustrating methods that support asset history based service predictions in accordance with aspects of the present disclosure.

### DETAILED DESCRIPTION

A user may utilize an asset management tool (e.g., existing asset management tools) to manage asset service actions (e.g., work orders) for one or more assets (e.g., appliances, tools, vehicles, machines, processors, computers etc.). The asset management tool may utilize provided and formatted data to track asset service actions and indicate scheduled asset service actions. In some cases, the existing asset management tools may not be capable of ingesting data from different data sources of different data organization models. For example, a user may input data from a data source manually, or the asset management tool may function with a subset of possible data organization models, increasing effort by the user to interact with the asset management tools. Additionally, the asset management tool may lack predictive capabilities for future asset service actions, or predictive capabilities of the asset management tool may be implemented by a user writing code, which may reduce a quantity of users who are capable of accessing the predictive capabilities, and may increase effort for utilizing the predictive capabilities. Moreover, as different data models and different assets may have different types of data, creating separate models for different asset type and different data models may be computationally inefficient (e.g., requiring significant processor and memory overhead), in addition to requiring additional human capital.

The techniques described herein support a user friendly and no-code user experience for ingesting data from one or multiple data sources of different data organization models, generating data sets (e.g., a training data set) based on the ingested data, and training an asset management model that may be used to predict future asset service actions. For example, the asset management model may ingest asset service action history data (e.g., also referred to herein as asset history data) from one or more different data sources of varying (e.g., differing) data organization models, transform the data from the one or more different data sources into a unified data model, generate an asset service action training data set from the ingested data (e.g., from the unified data model), and train a model (e.g., the asset management model) to predict future asset service actions using at least the asset service action training data set. In some cases, asset history data may indicate an identity, asset type, age, usage, service actions (e.g., repairs, maintenance), and other information associated with one or more assets. By ingesting (e.g., transforming) the data from different data sources based on the unified data model, generating (e.g., autonomously generating, through clicks from a user without the user writing code) the asset service action training data, and training the model based on the asset service action training data set, the asset management model may reduce a complexity associated with using the asset management model and reduce effort from a user to manage assets. Additionally, or alternatively, by training the model to predict future asset service actions, the asset management model may provide insight into upcoming issues associated with an asset, which may allow for reduced downtime of assets and reduced service person work time by handling multiple asset service actions in one service visit, which may increase utility of the asset and reduce costs associated with operating the asset.

In some examples, the unified data model may be a pre-configured data model that the asset management model may leverage for various asset types and various types of data associated with each asset type. For example, the pre-configured model may include one or more asset service action objects (e.g., a data model object (DMO), instances of an asset service action data type), each of which may include a first set of fields (e.g., a limited set of required fields, such as asset type, service history, age of the asset, install data, any combination thereof) and a second set of fields (e.g., optional fields). The first set of fields and the second set of fields may be linked to (e.g., filled with information according to) the customer data from the one or more data sources via a batch transformation. Additionally, users may add one or more custom fields to the pre-configured data model (e.g., to the second set of fields) to further enhance the predictive capabilities of the asset management model. In some cases, the asset management model ingesting different types of data according to the unified data model may reduce complexity and effort associated with using the asset management model. That is, the unified data model supports an extensible and scalable technique for generating and training a predictive model, and the unified data model may be applicable to various types and formats of input data and various types of assets.

In some cases, training the asset management model may include determining, for an asset type, one or more correlations between a temporally first service action and a temporally second service action based on the asset service action training data set. For example, the asset management model (e.g., after being trained) may receive an input indicating an asset type, a service action type (e.g., current service action type), an install date of the asset (e.g., an age of the asset), or any combination thereof, and may output an indication of one or more predicted (e.g., next, future) asset service actions for the asset type based on the training and the input. In some examples, the indications of the one or more predicted asset service actions may be based on a binary classification system. For example, the asset management model may generate the asset service training data set according to a binary classification system such that the trained asset management model may predict asset service actions according to the binary classification system. In some cases, such techniques may decrease a latency associated with the predictive capabilities of the asset management model, and may increase simplicity of using and understanding the output of the asset management model.

Aspects of the disclosure are initially described in the context of an environment supporting an on-demand database service. Aspects of the disclosure are also described with respect to data architecture diagrams, binary classification diagrams, and process flows. Aspects of the disclosure are further illustrated by and described with reference to apparatus diagrams, system diagrams, and flowcharts that relate to asset history based service predictions. In some aspects, the terms “model” and “asset management model” may be interchangeable. For example, the asset management model may be an ML model for predicting future asset service actions. Additionally, or alternatively, the asset management model may include user interfaces, software, or other components to receive and output data, and display information to a user.

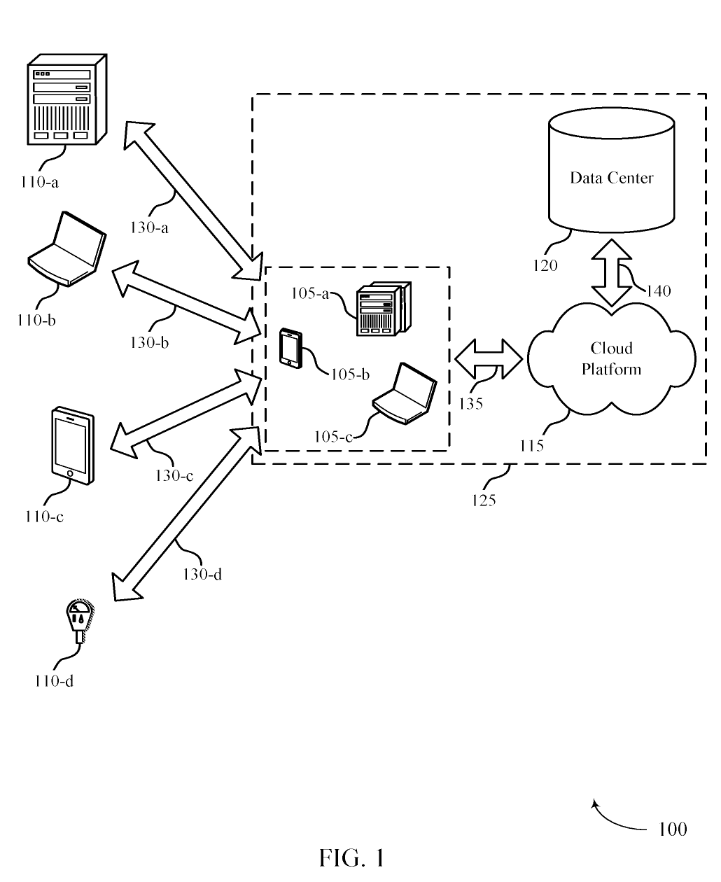

FIG. 1 illustrates an example of a system 100 for cloud computing that supports asset history based service predictions in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may support asset history based service predictions. For example, a cloud platform 115, a user device, or both, may support an asset management model (e.g., a software, a program) that may receive asset history data (e.g., associated with one or more assets of one or more asset types) from one or more data sources (e.g., including one or more other cloud platforms 115), such as data sources associated with one or more cloud clients 105. The asset management model may ingest the asset history data based on a unified data model, generate an asset service action training data set from the ingested data, and train a model for predicting asset service actions based on an inputted asset service action.

In some cases, a user may utilize an asset management tool to manage asset service actions (e.g., work orders) for one or more assets (e.g., appliances, tools, vehicles, machines, processors, computers etc.). The asset management tool may utilize provided and formatted data to predict or recommend work service actions. In some cases, the asset management tool may not be capable of ingesting data from different data sources of different data organization models. For example, a user may input data from a data source manually, or the asset management tool may function with a subset of possible data organization models, increasing effort by the user to interact with the asset management models. Additionally, some asset management tools may lack predictive capabilities. In some cases, predictive capabilities of an asset management tool may be implemented by a user writing code, which may reduce a quantity of users who are capable of accessing the predictive capabilities and may increase effort associated with utilizing the predictive capabilities. These deficiencies in asset management tools may increase service visits by a service person and may increase asset down time due to multiple service visits to handle multiple assert service actions.

The techniques described herein propose a user friendly and no-code user experience for ingesting data from one or multiple data sources, generating data sets (e.g., a training data set) based on the ingested data, and training an asset management model that may be used to predict service actions (e.g., future service actions, upcoming service actions). The asset management model may ingest asset history data from one or more different data sources, transform the data from the one or more different data sources according to a unified data model, generate an asset service action training data set from the ingested data (e.g., based on the unified data model), and train a model (e.g., the asset management model, using the asset service action training data set) to predict future asset service actions. For example, the asset management model may identify common failures (e.g., patterns of asset service actions, correlations between assert service actions over time) for an asset type based on asset history data and recommend likely asset service actions (e.g., next asset service actions) to the user.

By transforming the data from different data sources into a unified data model, generating (e.g., autonomously generating, through clicks from a user without the user writing code) the asset service action training data, and training the model based on the asset service action training data, the asset management model may reduce complexity of utilizing the asset management model and reduce effort from a user to manage assets (e.g., compared to other asset management tools). Additionally, or alternatively, by training the model to predict future asset service actions, the asset management model may provide insight into upcoming issues with an asset, which may allow for reduced downtime of assets and reduced service person work time by handling multiple asset service actions in one service visit, which may increase utility of the asset and reduce costs associated with operating the asset.

In some examples, the unified data model may be a pre-configured data model that the asset management model may leverage for various asset types associated with various types of data. For example, the pre-configured model may include one or more asset service action objects (e.g., a data model object (DMO), instances of an asset service action data type), each of which may include a first set of fields (e.g., a limited set of required fields, such as asset type, service history, age of the asset, install data, and combination thereof) and a second set fields (e.g., optional fields). The first set of fields and the second set of fields may be linked to (e.g., filled with information according to) the customer data from the one or more data sources. Additionally, users may add one or more custom fields to the pre-configured data model (e.g., to the second set of fields) to further enhance the predictive capabilities of the asset management model. In some cases, the asset management model ingesting different types of data according to the unified data model may reduce complexity and effort associated with using the asset management model. The unified data model and the model generation service described herein may be extensible and applicable to various types of assets and various data models. For example, a first organization or tenant may access the service and link associated data to the unified data model, and the associated data of the first tenant may have a first format and may be for a first asset type (e.g., vehicles). A second organization may access the service and link associated data to the unified data model, and the associated data of the second tenant may have a second format and may be for a second asset type (e.g., appliances). The model training service may generate respective models based on the respective data, without requiring specific types and/or formats of data.

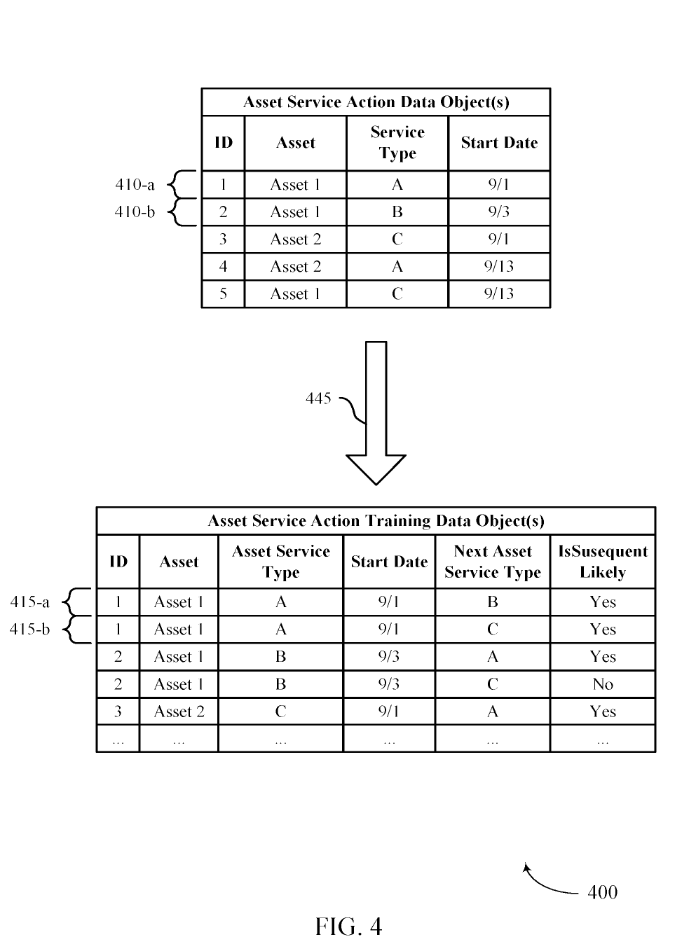

In some cases, training the asset management model may include the asset management model determining, for an asset type, one or more correlations between a temporally first service action type and a temporally second service action type for an asset type based on the asset service action training data set. For example, the asset management model (e.g., after being trained) may receive an input indicating an asset type, a service action type (e.g., a current or recent service action type), and an install date of the asset (e.g., an age of the asset), and may output an indication of one or more predicted (e.g., next, future) asset service actions for the asset type based on the training and the input. In some examples, the indications of the one or more predicted asset service actions may be based on a binary classification system (e.g., as described herein with respect to FIG. 4). In some cases, such techniques may decrease a latency associated with the predictive capabilities of the asset management model, and may increase simplicity of understanding predictions of the asset management model.

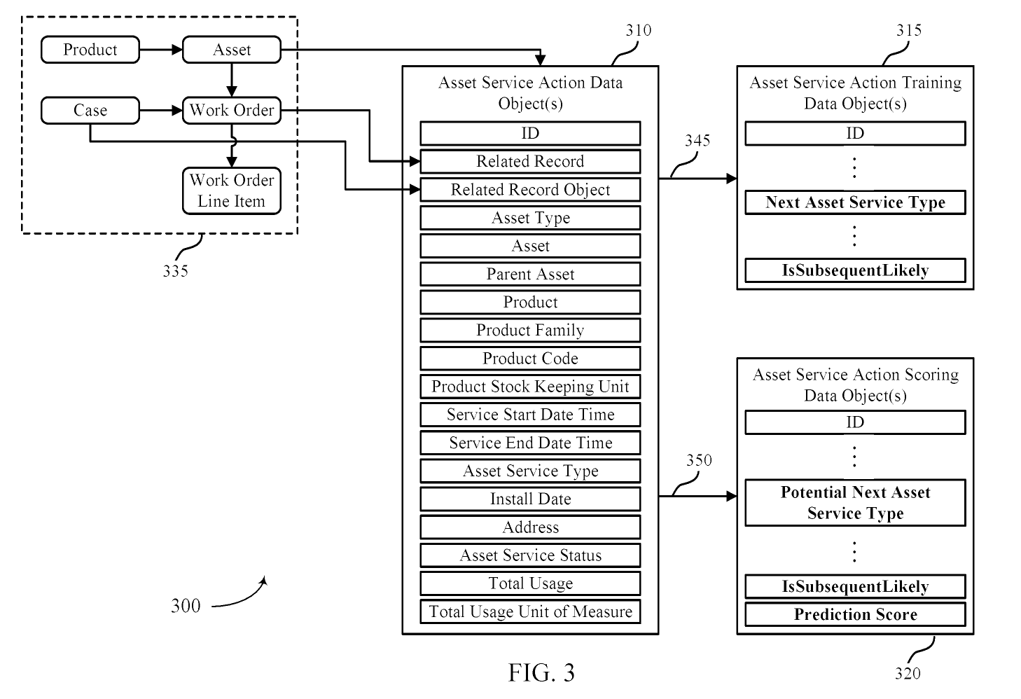

As an example, a user may apply the techniques described herein to manage a home appliance, such as a dishwasher. The user may link asset history data associated with the home appliance (e.g., associated with multiple assets similar to the home appliance or multiple assets of a same asset type as the home appliance) to the asset management model. For example, the user may input values or link a data base to the asset management model, where the asset history data may indicate information described with respect to FIG. 3. The asset management model may ingest the asset history data according to the unified model, generate an asset service action training data set from the ingested data, and train a model to predict future asset service actions based on the asset service action training data set. For example, the user (or a service provider) may encounter an issue with the home appliance (e.g., a water leak), and may input an indication of the issue into the asset management model (e.g., along with other information, such as an age of the home appliance), and the asset management model may output an indication of one or more predicted asset service actions (e.g., likely subsequent asset service actions) for the home appliance. For example, the asset management model may indicate that a predicted (e.g., typical) next part to fail after a water leak is a motor of the home appliance. In another example, a user may apply the asset management model to computer hardware. For example, the user may input an asset service action such as cleaning liquid spillage from a computer, and the asset management model may output an indication that a predicted next asset service action is to clean a keyboard of the computer and dry a computer chip of the computer (e.g., a motherboard). Thus, by consulting the asset management model with a current asset service action, multiple asset service actions may be indicated and handled in one asset service visit based on asset history data, which may reduce downtime and costs for servicing the asset.

It should be appreciated by a person skilled in the art that one or more aspects of the disclosure may be implemented in a system 100 to additionally, or alternatively, solve other problems than those described above. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

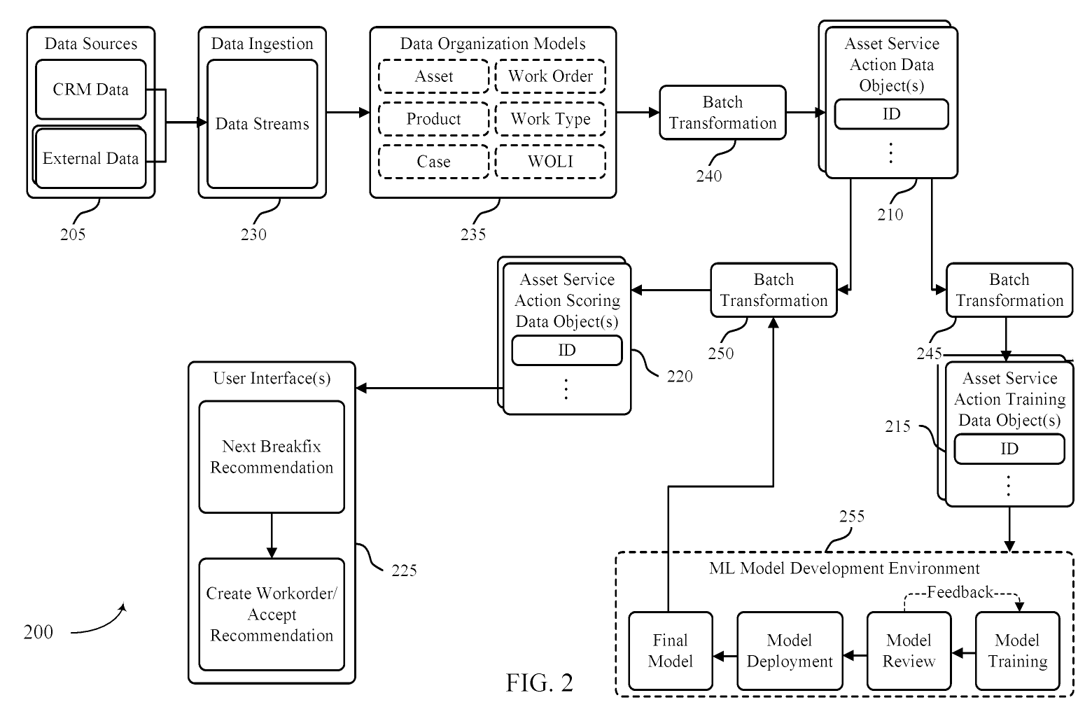

FIG. 2 shows an example of a data architecture diagram 200 that supports asset history based service predictions in accordance with aspects of the present disclosure. In some cases, aspects of the data architecture diagram 200 may implement or be implemented by aspects of FIG. 1. For example, the data architecture diagram 200 may include data sources 205, asset service action data objects 210 (e.g., DMOs, instances of an asset service action data type), asset service action training data objects 215 (e.g., instances of an asset service action training data type within an asset service action data training data set), and asset service action scoring data objects 220 (e.g., instances of an asset service action scoring data type within an asset service action data scoring data set), which may be examples of the data sources, asset service action objects, asset service action training data objects, and asset service action scoring data objects described herein with respect to FIG. 1. Additionally, or alternatively, the data architecture diagram 200 may be implemented at a cloud platform 115, user device (e.g., a cell phone, a tablet, a computer), or any combination thereof. In some aspects, the data architecture diagram 200 may illustrate an architecture for organizing and processing data using a unified data model to provide an asset management model that may predict asset service actions for an asset type.

In some cases, asset service action predictions may reduce service visits for an asset by predicting a likelihood (e.g., a binary likelihood, a “yes” or a “no,” a percentage likelihood) of a potential asset service action to be done within a threshold time from performing a current (e.g., recent) asset service action based on asset history data (e.g., Salesforce services repair history data). For example, the asset management model may predict a likelihood that performing a second asset service action (e.g., of type B) within a time period after performing a first asset service action (e.g., of type A) will be beneficial for an asset type based on (e.g., in response to receiving, as an input) information associated with the first asset service action. For example, for a dishwasher with a water leak, the asset management model may predict a likelihood of whether the dishwasher will experience an electrical malfunction associated with a motor of the dishwasher within a time period (e.g., 90 days) based on asset history data associated with similar dishwashers (e.g., the asset type).

In some cases, the asset management model may utilize a hyperscale platform (e.g., Data cloud) to ingest the asset history data from the multiple different data organization models 235 according to the unified data model. For example, a first data ingestion process 230 may be based on the hyperscale platform of the asset management model. For example, the first data ingestion process 230 may utilize a cloud platform 115 (e.g., as described with respect to FIG. 1) to connect the data sources (e.g., from a Salesforce application, an external DLO, a legacy system) to the data organization models 235 (e.g., a lake house architecture).

In some cases, the asset management model may be an entity agnostic model. For example, the asset service action data objects 210 (e.g., DMOs of the unified data model) may be filled with data (e.g., customer relationship management (CRM) data, other external data) from one or more different data sources 205, data organization models 235, or both. For example, through a first data ingestion process 230, the data from the data sources 205 may be transformed into one or more data organization models 235 (e.g., one or more entities, data lake objects (DLOs)). In some cases, the user, the asset management model, or both, may perform the first data ingestion process 230.

For example, a user may manage data (e.g., asset history data) from one or more data sources in different data organization models 235. For example, each data organization model 235 may include one or more data objects for storing and managing data associated with an asset, including cases, work orders, assets, products, work types, work order line items (WOLIs), or any combination thereof. In some cases, an asset data object may store asset data which may be manually or automatically updated (e.g., via internet of things (IoT) devices). For example, a vehicle may include a device (e.g., a chip, an IoT device) that sends signals indicating vehicle operation parameters (e.g., tire pressure, engine temperature, oil level) to the data organization model (e.g., in a computer system), updating the asset data object with current asset history data. A work order data object may represent a requested asset service action to be performed on an asset. A product data object may represent a product that the user manages (e.g., sells, produces, ships). A WOLI data object may represent a subtask on a work order. A case data object may represent an issue or problem with an asset.

Depending on a utilized data organization model 235, a user may organize or refer to assets differently. For example, a first user may track asset history data for a tire of a vehicle based on a first data organization model 235, and a second user track asset history data for an entire vehicle based on a second data organization model 235. However, via a batch transformation 240 (e.g., a second data ingestion process according to the unified data model), the asset management model may transform data from the one or more data organization models 235 into asset service action data objects 210 (e.g., according to the unified data model).

The batch transformation 240 may transform data from the data organization models 235 into asset service action data objects 210 (e.g., normalizing and de-normalizing the data, cleansing the data). The batch transformation 245, the batch transformation 250, or both (e.g., pre-built batch data transforms) may transform the asset service action data objects 210 into model inputs (e.g., machine learning (ML) model inputs, according to the unified data model). The batch transformation 245 may generate the asset service action training data objects 215 from one or more of the asset service action data objects 210, and the batch transformation 250 may generate one or more asset service action scoring data objects 220 from one or more of the asset service action data objects 210. In some cases, the user may perform one or more clicks to perform the batch transformations 240, 245, 250, or any combination thereof. Additionally, or alternatively, the batch transformation 240, the batch transformation 245, the batch transformation 250, or any combination thereof, may include performing a binary classification, such that each asset service action training data objects 215, each asset service action scoring data objects 220, or both, may include one or more binary (e.g., Boolean) fields (e.g., as described herein with respect to FIG. 4). The asset service action data objects 210, the asset service action training data objects 215, and the asset service action scoring data objects 220 may each include one or more fields, as described herein with respect to FIG. 3.

In some aspects, the asset management model may be a flexible data framework. For example, a user may update one or more aspects about the asset management model based on a useful prediction or other priority of the user. For example, the user may change a mapping between information in the data organization models 235 and the fields of the asset service action data objects 210. Additionally, or alternatively, the user may tune parameters associated with an ML model development environment 255 (e.g., Einstein Studio, the hyperscale platform, or any other aspect of the data architecture diagram 200) to increase accuracy or tailor the predictive capabilities of the asset management model for the user. In some cases, the asset management model may utilize an ML model development environment 255 (e.g., both) to perform some actions associated with training and deploying the asset management model, such as model training (e.g., using the asset service action training data objects 215), model review and an associated feedback loop, model deployment, and utilizing a final model in the batch transformation 250 to generate the asset service action scoring data objects 220.

In some cases, the ML model development environment 255 may support enhanced event sequencing for one or more actions (e.g., model training, model review, feedback). For example, the ML model development environment 255 may train the model to recognize patterns in asset service actions other than immediately next asset service repairs (e.g., beyond immediate repairs). In some cases, the ML model development environment 255 may train the model to recognize sequential asset service actions performed within an adjustable (e.g., pr fixed) duration from a first asset service action, such that the asset management model may predict multiple future asset service actions based on a single asset service action input. Additionally, or alternatively (e.g., if the data sources 205 are from a wide variety of geographic locations), the asset management model may make asset service action predictions based on trends associated with large geographic areas or various different geographic areas. For example, the asset management model may enable a user in a first geographic location (e.g., Los Angeles) to receive asset service action predictions based on asset service history data for similar assets in a second geographic location (e.g., New York).

In some cases, the asset management model may utilize one or more user interfaces 225. For example, the asset management model may prompt a user to input information associated with one or more asset service action (e.g., current issues associated with an asset, a current asset service action being performed on the asset) via a user interface 225, and may indicate a next asset service action, preventative actions associated with the asset, or both, via a user interface 225 (e.g., a same user interface 225, a different user interface 225). For example, the user interface 225 may include or be part of a cloud platform 115, a user device, or any combination thereof (e.g., a cell phone screen, a tablet screen, a computer screen).

In some cases, the asset management model may indicate one or more metrics associated with training the asset management model, associated with predictions made by the asset management model, associated with operating the asset management model, or any combination thereof, via a user interface 225 (e.g., a same user interface 225, a different user interface 225). For example, the user interface 225 may indicate one or more measurements of accuracy for the asset management model in predicting future asset service actions within a period of time from a first asset service action (e.g., a true positive rate, a true negative rate, a false positive rate, a false negative rate, any combination thereof), a ranking of importance of one or more variables of asset history data to accurately predict future asset service actions, or a combination thereof. In some cases, the asset management model may determine the one or more metrics by analyzing past predictions and past asset history data, by generating asset service action scoring data objects 220 from the ingested asset history data, by testing the asset management model using the asset service action scoring data set, or any combination thereof.

FIG. 3 shows an example of a data organization model 300 that supports asset history based service predictions in accordance with aspects of the present disclosure. In some cases, aspects of the data organization model 300 may implement or be implemented by aspects of FIGs. 1 and 2. For example, the data organization model 300 may illustrate a portion of the data architecture diagram 200, including data organization models 335 (e.g., such as data organization models 235), asset service action data objects 310 (e.g., such as asset service action data objects 210), asset service action training data objects 315 (e.g., such as asset service action training data objects 315), asset service action scoring data objects 320 (e.g., asset service action scoring data objects 220), batch transformation 345 (e.g., such as the batch transformation 245), and batch transformation 350 (e.g., such as the batch transformation 250). In some aspects, the data organization model 300 may illustrate one or more fields included in the asset service action data objects 310, asset service action training data objects 315, and asset service action scoring data objects 320, which may be used to train and evaluate the asset management model for predicting future asset service actions.

In some aspects, each asset service action data object 310 (e.g., each instance of an asset service action data type, each asset service action instance) may represent (e.g., denote) an asset service action (e.g., a repair) from the data organization models 335 according to the unified data model. For example, the fields in the asset service action data objects may be filled with information from one or more data organization models 335 (e.g., from the asset data object, product data object, work order data object, case data object, or any combination thereof), an external system, or both. Each asset service action data objects 310 may include a first set of fields (e.g., a required set of fields), which may include an asset type field, an asset service type (e.g., asset service action type) field, a service date field (e.g., one or more of a service start date time and a service end date time field), or any combination thereof. Additionally, or alternatively, each asset service action data objects 310 may include a second set of fields (e.g., optional fields), which may include an asset service action identification (ID) field, a parent asset field (e.g., to identify a parent asset that includes the asset, such as a vehicle including a tire), one or more product identifier fields (e.g., a product field, a product family field, a product code field), a start time field associated with the asset service action, an end time field associated with the asset service action, an asset service type field, a date of asset installation field (e.g., indicating an age of the asset), a geographic location field, an asset service status field, one or more asset usage fields (e.g., a total usage field and a usage unit of measure field, with values such as “150000” and “miles,” respectively, to indicate usage of a vehicle), or any combination thereof.

In some aspects, each asset service action training data object 315 (e.g., each instance of the asset service action training data type, each asset service action training instance) may be a resultant data object (e.g., DMO) of the batch transformation 345 on the asset service action data objects 310 (as described herein with respect to FIG. 4). In some cases, the ML model development environment 255 (e.g., as described with respect to FIG. 2) may receive the asset service action training data objects 315 to train the asset management model to predict future asset service actions. Each asset service action training data object 315 may include one or more of the fields described within the asset service action data objects 310, and may include one or more additional fields. For example, the one or more additional fields in the asset service action training data objects 315 may include a next asset service type field, which may indicate one or more chronologically subsequent asset service types for the corresponding asset type after a corresponding asset service type based on the asset service action data objects 310. The one or more additional fields may include an IsSubsequentLikely field (e.g., one or more Booleans values), which may indicate whether each asset service type indicated by the next asset service type field is likely (e.g., has a likelihood that satisfies a threshold likelihood value) based on the asset service action data objects 310. In some cases, the asset management model (e.g., or another entity) may determine a value of the IsSubssequentLikely field based on analyzing the asset service action data objects 310 to identify a frequency with which a next asset service type occurs within a period of time after a corresponding service action type.

In some aspects, each asset service action scoring data object 320 may be a resultant data object (e.g., DMO) from the batch transformation 350 on the asset service action data objects 310. Each asset service action scoring data objects 320 may include one or more fields included in the asset service action data objects 310, the asset service action training data objects 315, or both, and may further include one or more additional fields. For example, a trained asset management model may perform at least a portion of the batch transformation 350, such as predicting one or more potentially next asset service types to be included in an additional field (e.g., a potentially next asset service type field) of each asset service action scoring data objects 320. The asset management model may also predict whether each potentially next asset service types is likely (e.g., is associated with a likelihood that satisfied a threshold likelihood) and indicate the prediction in another additional field (e.g., the IsSubsequentLikely field). In some cases, the asset management model (e.g., or another entity) may score the predicted potentially next asset service actions, the predicted likelihoods, or both, based on asset history data (e.g., based on the asset service action data objects 310), and may indicate the score in another additional field (e.g., the prediction score field).

In some examples, the asset management model may utilize the asset service action data objects 310, asset service action training data objects 315, and asset service action scoring data objects 320 to ingest data according to the unified data model, and train a model (e.g., a ML model) to predict future asset service actions for an asset type based on a current asset service action. Such techniques may reduce complexity for a user to utilize the asset management model, and reduce costs in operating an asset (e.g., as described herein).

FIG. 4 shows an example of a binary classification diagram 400 that supports asset history based service predictions in accordance with aspects of the present disclosure. In some cases, aspects of the binary classification diagram 400 may implement or be implemented by aspects of FIGs. 1–3. For example, the binary classification diagram 400 may include one or more asset service action data objects 410 (e.g., asset service data object 410-a, asset service data object 410-b), a batch transformation 445, and one or more asset service action training data objects 415 (e.g., an asset service action training data objects 415-a, an asset service action training data objects 415-b), which may be examples of asset service action data objects 310, batch transformation 345, and asset service action training data objects 315, respectively, as described herein with respect to FIGs. 1–3. In some aspects, the binary classification diagram 400 may illustrate the batch transformation 445 generating the one or more asset service action training data objects 415 from the one or more asset service action data objects 410 according to a binary classification system, which may provide for less latency and complexity for the user of the asset management model.

In some aspects, each column of each asset service action data object 410 and one or more asset service action training data objects 415 may represent a field of each asset service action data objects 410 and asset service action training data objects 415, respectively (e.g., such as the similarly named fields described herein with respect FIG. 3). The binary classification diagram 400 may illustrate an exemplary quantity of fields of exemplary types, but additional or alternative columns could be added to each asset service action data objects 410 and asset service action training data objects 415 to indicate additional or alternative fields (e.g., such as the fields described herein with respect to FIG. 3). The assets indicated by the “Asset” column (e.g., Asset 1, Asset 2) may also be assets of a same asset type or a different asset type.

The batch transformation 445 may generate each asset service action training data object 415 based on an asset service action data object 410, where each asset service action training data objects 415 may include one or more additional columns (e.g., fields) compared to an asset service action data objects 410. For example, the batch transformation 445 may generate the asset service action training data objects 415-a and 415-b from the asset service data object 410-a, where each asset service action training data object 415 may include a “next asset service type” field and an “IsSubsequentLikely” field (e.g., as described herein with respect to FIG. 3). Thus, each asset service action training data object 415 may indicate whether, for an asset service type and for an asset (e.g., or an asset type), the next asset service type will occur next (e.g., has a likelihood to occur next that satisfies a threshold likelihood value). Additionally, or alternatively, the information of asset service action training data objects 415 that are associated with a same asset service action data object 410 (e.g., such as asset service action training data objects 415-a and asset service action training data objects 415-b) may be included in a same asset service action training data object 315 (as described herein with respect to FIG. 3), where the information of the next asset service type and IsSubsequentLikely columns may be included in the additional next asset service type field and IsSubsequentLikely field, respectively. The asset management model may be trained using the one or more asset service action training data objects 415, such that the asset management model may predict future asset service actions according to a similar binary classification system (e.g., a Boolean prediction).

In some cases, utilizing the binary classification system as described herein may increase simplicity and interpretability of the predicted future asset service actions. For example, a binary classification prediction may be conceptually simpler than a weighted recommendation prediction, allowing the user to interpret the predictions more easily. Additionally, or alternatively, utilizing the binary classification system may allow the asset management model to leveraging existing algorithms. For example, some ML algorithms may couple with binary classification system, and utilizing such ML algorithms may simplify the training process for the asset management model. Additionally, or alternatively, utilizing the binary classification system may add scalability and remove latency from the asset management model. For example, a binary classification system may be less computationally intensive for a device (e.g., a cloud platform, a user device, another device) to implement compared to other algorithms, which may reduce training time associated with the asset management model and increase a threshold (e.g., maximum) amount of asset history data that the asset management model may manage.

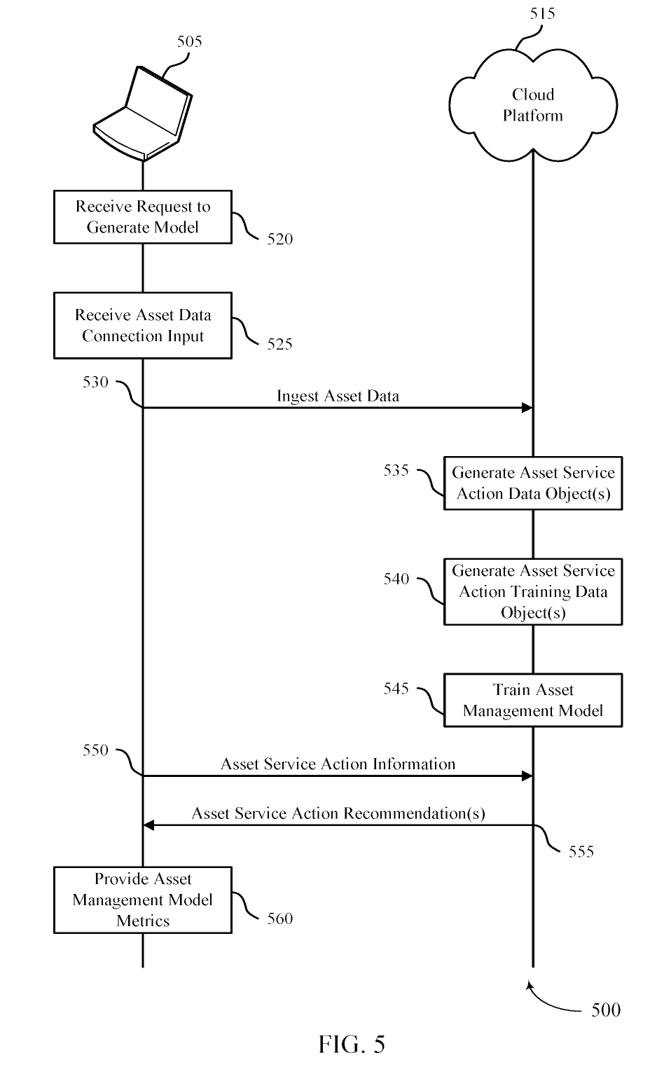

FIG. 5 shows an example of a process flow 500 that supports asset history based service predictions in accordance with aspects of the present disclosure. In some cases, aspects of the process flow 500 may implement or be implemented by aspects of FIGs. 1–4. For example, the process flow 500 may include a user device 505 and a cloud platform 515, which may be examples of the user devices and could platform 115, respectively, as described herein with respect to FIGs. 1–4. In some aspects, the process flow 500 may illustrate one or more operations which may be performed by the user device 505 and the could platform 515 to provide a user friendly and no-code user experience for ingesting data from one or multiple data sources of different data organization models, generating data sets based on the ingested data, training an asset management model that may be used to predict future asset service actions, and predicting one or more future asset service actions.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the user device 505 and the cloud platform 515 are shown performing the operations of process flow 500, some aspects of some operations may also be performed by one or more other devices. For example, a user may use the user device 505 to perform one or more of the operations of process flow 500, where the user may access the cloud platform 515 via a client on the user device 505.

At 520, the user device 505 may receive a first user input. In some cases, the first user input may include a request to generate a model (e.g., the asset management model) for predicting future asset service actions for one or more asset types. For example, the user device 505 may display one or more user interfaces (e.g., such as a user interface 225 described herein with respect to FIG. 2), and the user device 505 may receive the first user input via the user interface.

At 525, the user device 505 may receive, at the user interface or a different user interface, one or more second user inputs that connect asset data (e.g., asset history data) of one or more data stores to a unified data model associated with asset service action prediction. For example, the asset data may indicate a history of previous service actions of the one or more asset types. In some cases, the one or more second user inputs may include an indication that the could platform 515 is to ingest a data object of the one or more data stores as one or more predefined fields of the unified data model (e.g., as described herein with respect to FIG. 3).

At 530, the cloud platform 515 may ingest the asset data from the one or more data stores based on the one or more second user inputs. In some cases, the one or more data stores may include a first data store including a first data organization model and a second data store including a second data organization model different from the first data organization model (e.g., such as the data organization models 235, as described herein with respect to FIG. 2). Additionally, or alternatively, the data stores may include the data sources 205, data stores having the data organization models 235, or any combination thereof, as described herein with respect to FIG. 2.

At 535, the cloud platform 515 may generate one or more asset service action data objects (e.g., one or more asset service action instances) for each of the one or more asset types based on the unified data model. In some cases, each asset service action instance may correspond to an asset service action of the asset data. Additionally, or alternatively, each asset service action instance may include an asset type field, a service type field (e.g., an asset service type field), and a service date field (e.g., the first set of fields, the required fields). In some cases, each asset service action instance may further include a parent asset field, one or more product identifier fields, a start time field associated with the asset service action, an end time field associated with the asset service action, a date of asset installation field, a geographic location field, an asset service status field, one or more asset usage fields, or any combination thereof (e.g., as described herein with respect to FIG. 3).

At 540, the cloud platform 515 may generate an asset service action training data set (e.g., one or more asset service action training data objects) based on the ingested asset data. In some cases, generating the asset service action training data set may include transforming the ingested asset data (e.g., or the asset service action instances) into a plurality of entries, where each entry of the plurality of entries may include an asset type field, an asset service action type field, a next asset service action type field, and a binary prediction field (e.g., as described herein with respect to FIG. 4).

At 545, the cloud platform 515 may train a model (e.g., the asset management model) to predict future asset service actions based on the asset service action training data set. For example, the cloud platform 515 may train the model based on the plurality of entries described at 540.

At 550, the user device 505, the cloud platform 515, or both, may receive information associated with an asset service action for an asset type of the one or more asset types. For example, if the cloud platform 515 implements the asset management model, the user device 505 may receive user input indicating the information and communicate the information to the cloud platform 515. Additionally, or alternatively, if user device 505 implements the asset management model, the user device 505 may receive the information and may refrain from communicating the information with the cloud platform 515.

At 555, based on where the asset management model is implemented (e.g., as described at 550), the user device 505, the cloud platform 515, or both, may provide (e.g., via the asset management model) one or more recommendations for one or more future asset service actions for the asset type based on training the model and the received information. In some cases, providing the one or more recommendations may include assigning a relative likelihood (e.g., a binary likelihood score) score to each of the one or more future asset service actions based on training the model and the information (e.g., as described herein with respect to FIGs. 2–4).

At 560, the user device 505 may provide (e.g., in response to the cloud platform training the model) a user interface (e.g., a second user interface, the same or different from the other user interfaces) that include (e.g., displays) one or more indications of one or more metrics associated with training the model (e.g., as described herein with respect to FIG. 2). In some cases, the cloud platform 515 may transmit the one or more metrics to the user device to display via the user interface in response to training (e.g., and testing, and scoring) the asset management model.

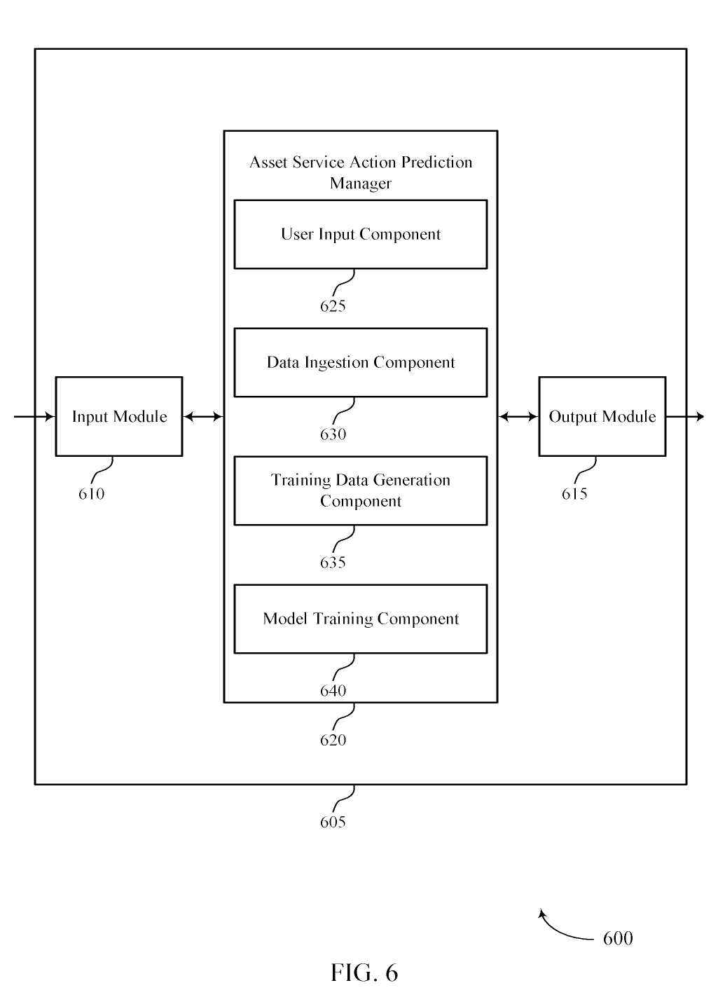

FIG. 6 shows a block diagram 600 of a device 605 that supports asset history based service predictions in accordance with aspects of the present disclosure. The device 605 may include an input module 610, an output module 615, and an asset service action prediction manager 620. The device 605, or one or more components of the device 605 (e.g., the input module 610, the output module 615, the asset service action prediction manager 620), may include at least one processor, which may be coupled with at least one memory, to support the described techniques. Each of these components may be in communication with one another (e.g., via one or more buses).

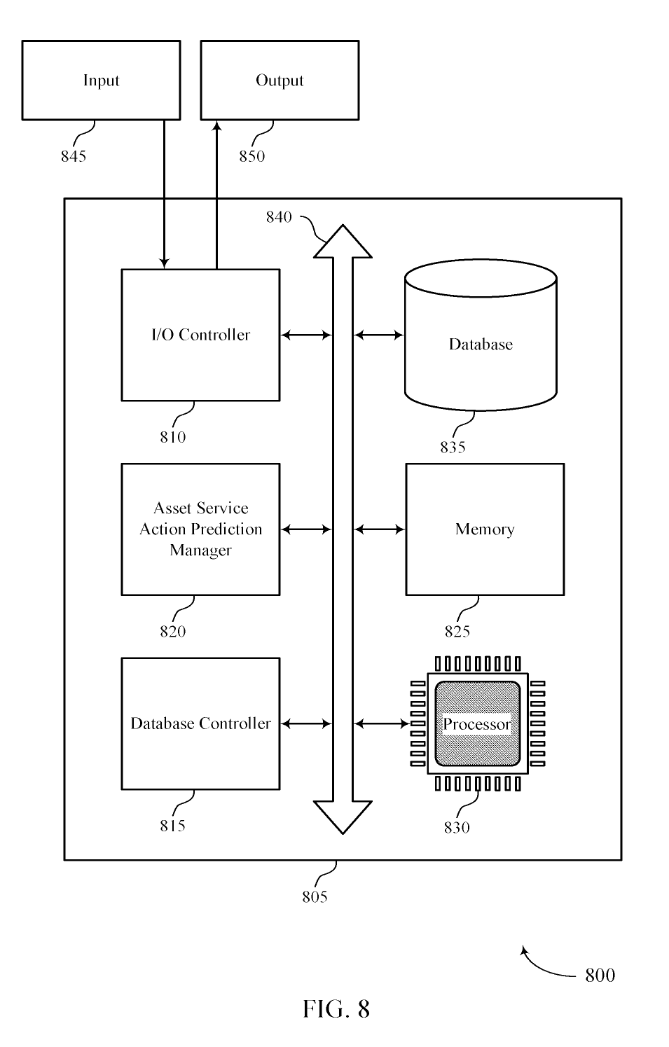

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the asset service action prediction manager 620 to support asset history based service predictions. In some cases, the input module 610 may be a component of an input/output (I/O) controller 810 as described with reference to FIG. 8.

The output module 615 may manage output signals for the device 605. For example, the output module 615 may receive signals from other components of the device 605, such as the asset service action prediction manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the asset service action prediction manager 620 may include a user input component 625, a data ingestion component 630, a training data generation component 635, a model training component 640, or any combination thereof. In some examples, the asset service action prediction manager 620, or various components thereof, may be configured to perform various operations (e.g., receiving, monitoring, transmitting) using or otherwise in cooperation with the input module 610, the output module 615, or both. For example, the asset service action prediction manager 620 may receive information from the input module 610, send information to the output module 615, or be integrated in combination with the input module 610, the output module 615, or both to receive information, transmit information, or perform various other operations as described herein.

The asset service action prediction manager 620 may support data processing in accordance with examples as disclosed herein. The user input component 625 may be configured to support receiving first user input including a request to generate a model for predicting future asset service actions for one or more asset types. The user input component 625 may be configured to support receiving, at a user interface, one or more second user inputs that connect asset data of one or more data stores to a unified data model associated with asset service action prediction, where the asset data indicates a history of previous service actions of the one or more asset types. The data ingestion component 630 may be configured to support ingesting the asset data from the one or more data stores based on the one or more second user inputs that connect the asset data to the unified data model. The training data generation component 635 may be configured to support generating an asset service action training data set based on the ingested asset data. The model training component 640 may be configured to support training the model to predict future asset service actions based on the asset service action training data set.

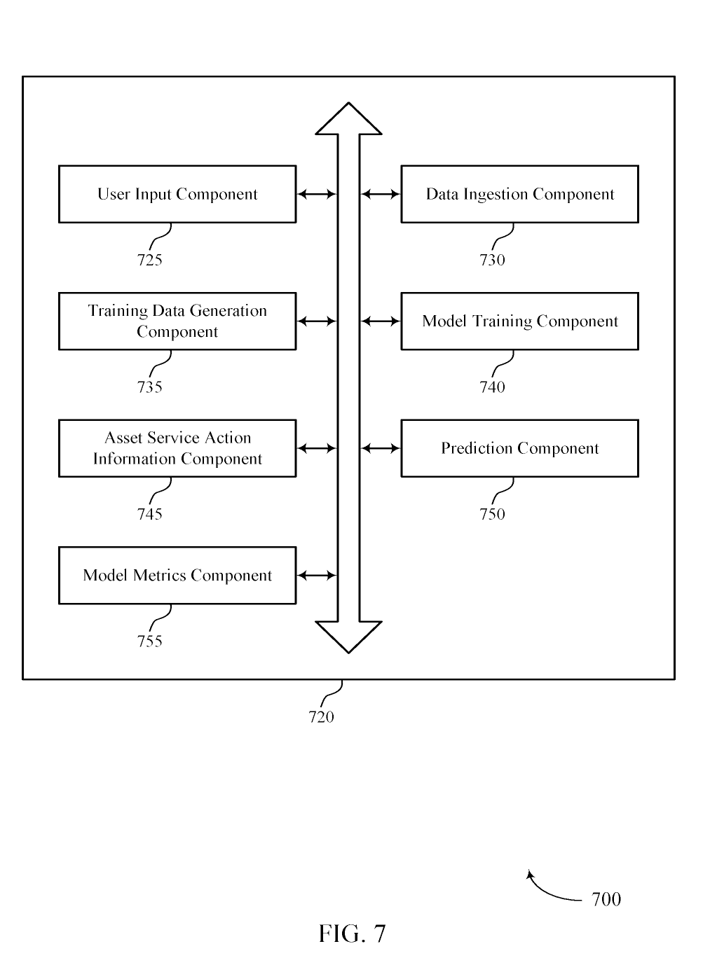

FIG. 7 shows a block diagram 700 of an asset service action prediction manager 720 that supports asset history based service predictions in accordance with aspects of the present disclosure. The asset service action prediction manager 720 may be an example of aspects of an asset service action prediction manager or an asset service action prediction manager 620, or both, as described herein. The asset service action prediction manager 720, or various components thereof, may be an example of means for performing various aspects of asset history based service predictions as described herein. For example, the asset service action prediction manager 720 may include a user input component 725, a data ingestion component 730, a training data generation component 735, a model training component 740, an asset service action information component 745, a prediction component 750, a model metrics component 755, or any combination thereof. Each of these components, or components of subcomponents thereof (e.g., one or more processors, one or more memories), may communicate, directly or indirectly, with one another (e.g., via one or more buses).

The asset service action prediction manager 720 may support data processing in accordance with examples as disclosed herein. The user input component 725 may be configured to support receiving first user input including a request to generate a model for predicting future asset service actions for one or more asset types. In some examples, the user input component 725 may be configured to support receiving, at a user interface, one or more second user inputs that connect asset data of one or more data stores to a unified data model associated with asset service action prediction, where the asset data indicates a history of previous service actions of the one or more asset types. The data ingestion component 730 may be configured to support ingesting the asset data from the one or more data stores based on the one or more second user inputs that connect the asset data to the unified data model. The training data generation component 735 may be configured to support generating an asset service action training data set based on the ingested asset data. The model training component 740 may be configured to support training the model to predict future asset service actions based on the asset service action training data set.

In some examples, the asset service action information component 745 may be configured to support receiving information associated with an asset service action for an asset type of the one or more asset types. In some examples, the prediction component 750 may be configured to support providing, via the model for predicting future asset service actions, one or more recommendations for one or more future asset service actions for the asset type based on training the model and the information.

In some examples, to support providing one or more recommendations for one or more future asset service actions, the prediction component 750 may be configured to support assigning a relative likelihood score to each of the one or more future asset service actions based on training the model and the information.

In some examples, to support ingesting the asset data according to the unified data model, the data ingestion component 730 may be configured to support generating one or more asset service action instances for each of the one or more asset types based on the unified data model, where each asset service action instance corresponds to an asset service action of the asset data, and where each asset service action instance includes an asset type field, a service type field, and a service date field.

In some examples, each asset service action instance further includes a parent asset field, one or more product identifier fields, a start time field associated with the asset service action, an end time field associated with the asset service action, a date of asset installation field, a geographic location field, an asset service status field, one or more asset usage fields, or any combination thereof.

In some examples, to support generating the asset service action training data set, the training data generation component 735 may be configured to support transforming the ingested asset data into a set of multiple entries, where each entry of the set of multiple entries includes an asset type field, an asset service action type field, a next asset service action type field, and a binary prediction field, where the model is trained based on the set of multiple entries.

In some examples, the one or more data stores include a first data store including a first data organization model and a second data store including a second data organization model different from the first data organization model.

In some examples, to support receiving the one or more second user inputs, the user input component 725 may be configured to support receiving an indication that a data object of the one or more data stores is to be ingested as one or more predefined fields of the unified data model.

In some examples, the model metrics component 755 may be configured to support providing, in response to training the model, a second user interface that includes one or more indications of one or more metrics associated with training the model.

FIG. 8 shows a diagram of a system 800 including a device 805 that supports asset history based service predictions in accordance with aspects of the present disclosure. The device 805 may be an example of or include components of a device 605 as described herein. The device 805 may include components for bi-directional data communications including components for transmitting and receiving communications, such as an asset service action prediction manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting asset history based service predictions). The processor 830 may be an example of a single processor or multiple processors. For example, the device 805 may include one or more processors 830.

The asset service action prediction manager 820 may support data processing in accordance with examples as disclosed herein. For example, the asset service action prediction manager 820 may be configured to support receiving first user input including a request to generate a model for predicting future asset service actions for one or more asset types. The asset service action prediction manager 820 may be configured to support receiving, at a user interface, one or more second user inputs that connect asset data of one or more data stores to a unified data model associated with asset service action prediction, where the asset data indicates a history of previous service actions of the one or more asset types. The asset service action prediction manager 820 may be configured to support ingesting the asset data from the one or more data stores based on the one or more second user inputs that connect the asset data to the unified data model. The asset service action prediction manager 820 may be configured to support generating an asset service action training data set based on the ingested asset data. The asset service action prediction manager 820 may be configured to support training the model to predict future asset service actions based on the asset service action training data set.

By including or configuring the asset service action prediction manager 820 in accordance with examples as described herein, the device 805 may support techniques for reduced latency and improved user experience related to reduced processing. For example, by training the asset management model and predicting future asset service action according to a binary classification system, a processing system may reduce latency and processing, improving user experience.

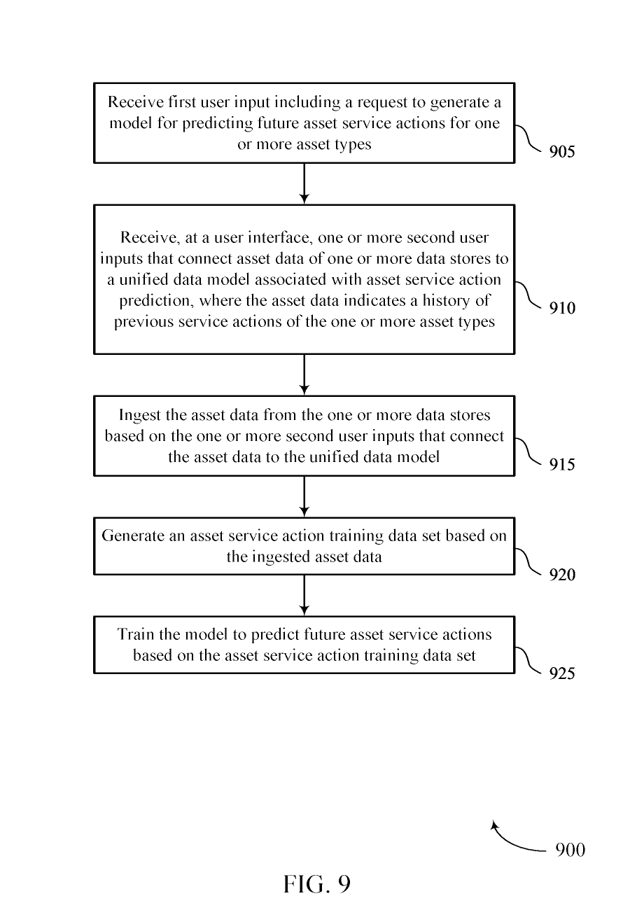

FIG. 9 shows a flowchart illustrating a method 900 that supports asset history based service predictions in accordance with aspects of the present disclosure. The operations of the method 900 may be implemented by a Salesforce Device or its components as described herein. For example, the operations of the method 900 may be performed by a Salesforce Device as described with reference to FIGs. 1 through 8. In some examples, a Salesforce Device may execute a set of instructions to control the functional elements of the Salesforce Device to perform the described functions. Additionally, or alternatively, the Salesforce Device may perform aspects of the described functions using special-purpose hardware.

At 905, the method may include receiving first user input including a request to generate a model for predicting future asset service actions for one or more asset types. The operations of 905 may be performed in accordance with examples as disclosed herein. In some examples, aspects of the operations of 905 may be performed by a user input component 725 as described with reference to FIG. 7.

At 910, the method may include receiving, at a user interface, one or more second user inputs that connect asset data of one or more data stores to a unified data model associated with asset service action prediction, where the asset data indicates a history of previous service actions of the one or more asset types. The operations of 910 may be performed in accordance with examples as disclosed herein. In some examples, aspects of the operations of 910 may be performed by a user input component 725 as described with reference to FIG. 7.

At 915, the method may include ingesting the asset data from the one or more data stores based on the one or more second user inputs that connect the asset data to the unified data model. The operations of 915 may be performed in accordance with examples as disclosed herein. In some examples, aspects of the operations of 915 may be performed by a data ingestion component 730 as described with reference to FIG. 7.

At 920, the method may include generating an asset service action training data set based on the ingested asset data. The operations of 920 may be performed in accordance with examples as disclosed herein. In some examples, aspects of the operations of 920 may be performed by a training data generation component 735 as described with reference to FIG. 7.

At 925, the method may include training the model to predict future asset service actions based on the asset service action training data set. The operations of 925 may be performed in accordance with examples as disclosed herein. In some examples, aspects of the operations of 925 may be performed by a model training component 740 as described with reference to FIG. 7.

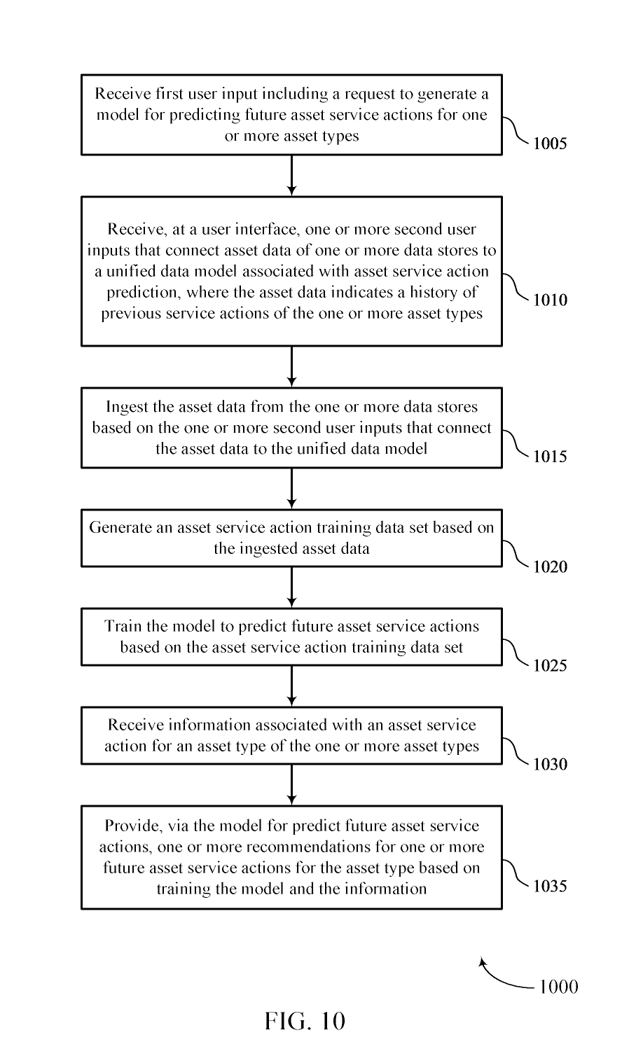

FIG. 10 shows a flowchart illustrating a method 1000 that supports asset history based service predictions in accordance with aspects of the present disclosure. The operations of the method 1000 may be implemented by a Salesforce Device or its components as described herein. For example, the operations of the method 1000 may be performed by a Salesforce Device as described with reference to FIGs. 1 through 8. In some examples, a Salesforce Device may execute a set of instructions to control the functional elements of the Salesforce Device to perform the described functions. Additionally, or alternatively, the Salesforce Device may perform aspects of the described functions using special-purpose hardware.

At 1005, the method may include receiving first user input including a request to generate a model for predicting future asset service actions for one or more asset types. The operations of 1005 may be performed in accordance with examples as disclosed herein. In some examples, aspects of the operations of 1005 may be performed by a user input component 725 as described with reference to FIG. 7.

At 1010, the method may include receiving, at a user interface, one or more second user inputs that connect asset data of one or more data stores to a unified data model associated with asset service action prediction, where the asset data indicates a history of previous service actions of the one or more asset types. The operations of 1010 may be performed in accordance with examples as disclosed herein. In some examples, aspects of the operations of 1010 may be performed by a user input component 725 as described with reference to FIG. 7.

At 1015, the method may include ingesting the asset data from the one or more data stores based on the one or more second user inputs that connect the asset data to the unified data model. The operations of 1015 may be performed in accordance with examples as disclosed herein. In some examples, aspects of the operations of 1015 may be performed by a data ingestion component 730 as described with reference to FIG. 7.

At 1020, the method may include generating an asset service action training data set based on the ingested asset data. The operations of 1020 may be performed in accordance with examples as disclosed herein. In some examples, aspects of the operations of 1020 may be performed by a training data generation component 735 as described with reference to FIG. 7.

At 1025, the method may include training the model to predict future asset service actions based on the asset service action training data set. The operations of 1025 may be performed in accordance with examples as disclosed herein. In some examples, aspects of the operations of 1025 may be performed by a model training component 740 as described with reference to FIG. 7.

At 1030, the method may include receiving information associated with an asset service action for an asset type of the one or more asset types. The operations of 1030 may be performed in accordance with examples as disclosed herein. In some examples, aspects of the operations of 1030 may be performed by an asset service action information component 745 as described with reference to FIG. 7.

At 1035, the method may include providing, via the model for predicting future asset service actions, one or more recommendations for one or more future asset service actions for the asset type based on training the model and the information. The operations of 1035 may be performed in accordance with examples as disclosed herein. In some examples, aspects of the operations of 1035 may be performed by a prediction component 750 as described with reference to FIG. 7.

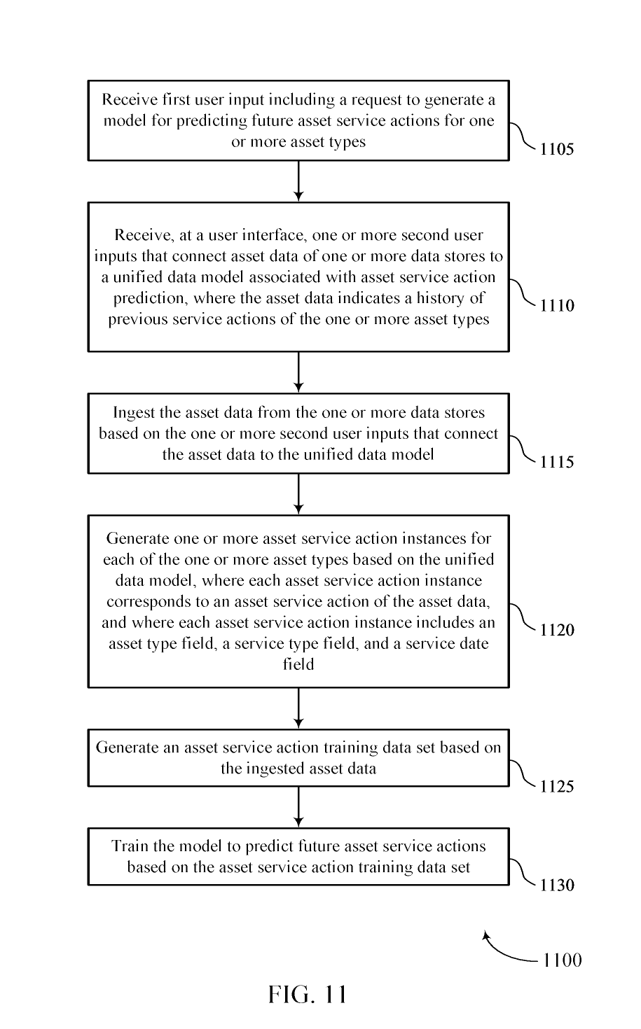

FIG. 11 shows a flowchart illustrating a method 1100 that supports asset history based service predictions in accordance with aspects of the present disclosure. The operations of the method 1100 may be implemented by a Salesforce Device or its components as described herein. For example, the operations of the method 1100 may be performed by a Salesforce Device as described with reference to FIGs. 1 through 8. In some examples, a Salesforce Device may execute a set of instructions to control the functional elements of the Salesforce Device to perform the described functions. Additionally, or alternatively, the Salesforce Device may perform aspects of the described functions using special-purpose hardware.

At 1105, the method may include receiving first user input including a request to generate a model for predicting future asset service actions for one or more asset types. The operations of 1105 may be performed in accordance with examples as disclosed herein. In some examples, aspects of the operations of 1105 may be performed by a user input component 725 as described with reference to FIG. 7.

At 1110, the method may include receiving, at a user interface, one or more second user inputs that connect asset data of one or more data stores to a unified data model associated with asset service action prediction, where the asset data indicates a history of previous service actions of the one or more asset types. The operations of 1110 may be performed in accordance with examples as disclosed herein. In some examples, aspects of the operations of 1110 may be performed by a user input component 725 as described with reference to FIG. 7.

At 1115, the method may include ingesting the asset data from the one or more data stores based on the one or more second user inputs that connect the asset data to the unified data model. The operations of 1115 may be performed in accordance with examples as disclosed herein. In some examples, aspects of the operations of 1115 may be performed by a data ingestion component 730 as described with reference to FIG. 7.

At 1120, the method may include generating one or more asset service action instances for each of the one or more asset types based on the unified data model, where each asset service action instance corresponds to an asset service action of the asset data, and where each asset service action instance includes an asset type field, a service type field, and a service date field. The operations of 1120 may be performed in accordance with examples as disclosed herein. In some examples, aspects of the operations of 1120 may be performed by a data ingestion component 730 as described with reference to FIG. 7.

At 1125, the method may include generating an asset service action training data set based on the ingested asset data. The operations of 1125 may be performed in accordance with examples as disclosed herein. In some examples, aspects of the operations of 1125 may be performed by a training data generation component 735 as described with reference to FIG. 7.

At 1130, the method may include training the model to predict future asset service actions based on the asset service action training data set. The operations of 1130 may be performed in accordance with examples as disclosed herein. In some examples, aspects of the operations of 1130 may be performed by a model training component 740 as described with reference to FIG. 7.

A method for data processing by an apparatus is described. The method may include receiving first user input including a request to generate a model for predicting future asset service actions for one or more asset types, receiving, at a user interface, one or more second user inputs that connect asset data of one or more data stores to a unified data model associated with asset service action prediction, where the asset data indicates a history of previous service actions of the one or more asset types, ingesting the asset data from the one or more data stores based on the one or more second user inputs that connect the asset data to the unified data model, generating an asset service action training data set based on the ingested asset data, and training the model to predict future asset service actions based on the asset service action training data set.

An apparatus for data processing is described. The apparatus may include one or more memories storing processor executable code, and one or more processors coupled with the one or more memories. The one or more processors may individually or collectively be operable to execute the code to cause the apparatus to receive first user input including a request to generate a model for predicting future asset service actions for one or more asset types, receive, at a user interface, one or more second user inputs that connect asset data of one or more data stores to a unified data model associated with asset service action prediction, where the asset data indicates a history of previous service actions of the one or more asset types, ingest the asset data from the one or more data stores based on the one or more second user inputs that connect the asset data to the unified data model, generate an asset service action training data set based on the ingested asset data, and train the model to predict future asset service actions based on the asset service action training data set.

Another apparatus for data processing is described. The apparatus may include means for receiving first user input including a request to generate a model for predicting future asset service actions for one or more asset types, means for receiving, at a user interface, one or more second user inputs that connect asset data of one or more data stores to a unified data model associated with asset service action prediction, where the asset data indicates a history of previous service actions of the one or more asset types, means for ingesting the asset data from the one or more data stores based on the one or more second user inputs that connect the asset data to the unified data model, means for generating an asset service action training data set based on the ingested asset data, and means for training the model to predict future asset service actions based on the asset service action training data set.

A non-transitory computer-readable medium storing code for data processing is described. The code may include instructions executable by one or more processors to receive first user input including a request to generate a model for predicting future asset service actions for one or more asset types, receive, at a user interface, one or more second user inputs that connect asset data of one or more data stores to a unified data model associated with asset service action prediction, where the asset data indicates a history of previous service actions of the one or more asset types, ingest the asset data from the one or more data stores based on the one or more second user inputs that connect the asset data to the unified data model, generate an asset service action training data set based on the ingested asset data, and train the model to predict future asset service actions based on the asset service action training data set.

Some examples of the method, apparatus, and non-transitory computer-readable medium described herein may further include operations, features, means, or instructions for receiving information associated with an asset service action for an asset type of the one or more asset types and providing, via the model for predicting future asset service actions, one or more recommendations for one or more future asset service actions for the asset type based on training the model and the information.

In some examples of the method, apparatus, and non-transitory computer-readable medium described herein, providing one or more recommendations for one or more future asset service actions may include operations, features, means, or instructions for assigning a relative likelihood score to each of the one or more future asset service actions based on training the model and the information.

In some examples of the method, apparatus, and non-transitory computer-readable medium described herein, ingesting the asset data according to the unified data model may include operations, features, means, or instructions for generating one or more asset service action instances for each of the one or more asset types based on the unified data model, where each asset service action instance corresponds to an asset service action of the asset data, and where each asset service action instance includes an asset type field, a service type field, and a service date field.

In some examples of the method, apparatus, and non-transitory computer-readable medium described herein, each asset service action instance further includes a parent asset field, one or more product identifier fields, a start time field associated with the asset service action, an end time field associated with the asset service action, a date of asset installation field, a geographic location field, an asset service status field, one or more asset usage fields, or any combination thereof.

In some examples of the method, apparatus, and non-transitory computer-readable medium described herein, generating the asset service action training data set may include operations, features, means, or instructions for transforming the ingested asset data into a set of multiple entries, where each entry of the set of multiple entries includes an asset type field, an asset service action type field, a next asset service action type field, and a binary prediction field, where the model may be trained based on the set of multiple entries.

In some examples of the method, apparatus, and non-transitory computer-readable medium described herein, the one or more data stores include a first data store including a first data organization model and a second data store including a second data organization model different from the first data organization model.

In some examples of the method, apparatus, and non-transitory computer-readable medium described herein, receiving the one or more second user inputs may include operations, features, means, or instructions for receiving an indication that a data object of the one or more data stores may be to be ingested as one or more predefined fields of the unified data model.

Some examples of the method, apparatus, and non-transitory computer-readable medium described herein may further include operations, features, means, or instructions for providing, in response to training the model, a second user interface that includes one or more indications of one or more metrics associated with training the model.

### The following provides an overview of aspects of the present disclosure:

Aspect 1: A method for data processing, comprising: receiving first user input comprising a request to generate a model for predicting future asset service actions for one or more asset types; receiving, at a user interface, one or more second user inputs that connect asset data of one or more data stores to a unified data model associated with asset service action prediction, wherein the asset data indicates a history of previous service actions of the one or more asset types; ingesting the asset data from the one or more data stores based at least in part on the one or more second user inputs that connect the asset data to the unified data model; generating an asset service action training data set based at least in part on the ingested asset data; and training the model to predict future asset service actions based at least in part on the asset service action training data set.

Aspect 2: The method of aspect 1, further comprising: receiving information associated with an asset service action for an asset type of the one or more asset types; and providing, via the model for predicting future asset service actions, one or more recommendations for one or more future asset service actions for the asset type based at least in part on training the model and the information.

Aspect 3: The method of aspect 2, wherein providing one or more recommendations for one or more future asset service actions comprises: assigning a relative likelihood score to each of the one or more future asset service actions based at least in part on training the model and the information.

Aspect 4: The method of any of aspects 1 through 3, wherein ingesting the asset data according to the unified data model comprises: generating one or more asset service action instances for each of the one or more asset types based at least in part on the unified data model, wherein each asset service action instance corresponds to an asset service action of the asset data, and wherein each asset service action instance comprises an asset type field, a service type field, and a service date field.

Aspect 5: The method of aspect 4, wherein each asset service action instance further comprises a parent asset field, one or more product identifier fields, a start time field associated with the asset service action, an end time field associated with the asset service action, a date of asset installation field, a geographic location field, an asset service status field, one or more asset usage fields, or any combination thereof.

Aspect 6: The method of any of aspects 1 through 5, wherein generating the asset service action training data set comprises: transforming the ingested asset data into a plurality of entries, wherein each entry of the plurality of entries comprises an asset type field, an asset service action type field, a next asset service action type field, and a binary prediction field, wherein the model is trained based at least in part on the plurality of entries.

Aspect 7: The method of any of aspects 1 through 6, wherein the one or more data stores include a first data store comprising a first data organization model and a second data store comprising a second data organization model different from the first data organization model.

Aspect 8: The method of any of aspects 1 through 7, wherein receiving the one or more second user inputs comprises: receiving an indication that a data object of the one or more data stores is to be ingested as one or more predefined fields of the unified data model.

Aspect 9: The method of any of aspects 1 through 8, further comprising: providing, in response to training the model, a second user interface that comprises one or more indications of one or more metrics associated with training the model.

Aspect 10: An apparatus for data processing, comprising one or more memories storing processor-executable code, and one or more processors coupled with the one or more memories and individually or collectively operable to execute the code to cause the apparatus to perform a method of any of aspects 1 through 9.

Aspect 11: An apparatus for data processing, comprising at least one means for performing a method of any of aspects 1 through 9.

Aspect 12: A non-transitory computer-readable medium storing code for data processing, the code comprising instructions executable by one or more processors to perform a method of any of aspects 1 through 9.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving first user input comprising a request to generate a model for predicting future asset service actions for one or more asset types;
receiving, at a user interface, one or more second user inputs that connect asset data of one or more data stores to a unified data model associated with asset service action prediction, wherein the asset data indicates a history of previous service actions of the one or more asset types;
ingesting the asset data from the one or more data stores based at least in part on the one or more second user inputs that connect the asset data to the unified data model;
generating an asset service action training data set based at least in part on the ingested asset data; and
training the model to predict future asset service actions based at least in part on the asset service action training data set.

2. The method of claim 1, further comprising:
receiving information associated with an asset service action for an asset type of the one or more asset types; and
providing, via the model for predicting future asset service actions, one or more recommendations for one or more future asset service actions for the asset type based at least in part on training the model and the information.

3. The method of claim 2, wherein providing one or more recommendations for one or more future asset service actions comprises:
assigning a relative likelihood score to each of the one or more future asset service actions based at least in part on training the model and the information.

4. The method of claim 1, wherein ingesting the asset data according to the unified data model comprises:
generating one or more asset service action instances for each of the one or more asset types based at least in part on the unified data model, wherein each asset service action instance corresponds to an asset service action of the asset data, and wherein each asset service action instance comprises an asset type field, a service type field, and a service date field.

5. The method of claim 4, wherein each asset service action instance further comprises a parent asset field, one or more product identifier fields, a start time field associated with the asset service action, an end time field associated with the asset service action, a date of asset installation field, a geographic location field, an asset service status field, one or more asset usage fields, or any combination thereof.

6. The method of claim 1, wherein generating the asset service action training data set comprises:
transforming the ingested asset data into a plurality of entries, wherein each entry of the plurality of entries comprises an asset type field, an asset service action type field, a next asset service action type field, and a binary prediction field, wherein the model is trained based at least in part on the plurality of entries.

7. The method of claim 1, wherein the one or more data stores include a first data store comprising a first data organization model and a second data store comprising a second data organization model different from the first data organization model.

8. The method of claim 1, wherein receiving the one or more second user inputs comprises:
receiving an indication that a data object of the one or more data stores is to be ingested as one or more predefined fields of the unified data model.

9. The method of claim 1, further comprising:
providing, in response to training the model, a second user interface that comprises one or more indications of one or more metrics associated with training the model.

10. An apparatus for data processing, comprising:
one or more memories storing processor-executable code; and
one or more processors coupled with the one or more memories and individually or collectively operable to execute the code to cause the apparatus to:
receive first user input comprising a request to generate a model for predicting future asset service actions for one or more asset types;
receive, at a user interface, one or more second user inputs that connect asset data of one or more data stores to a unified data model associated with asset service action prediction, wherein the asset data indicates a history of previous service actions of the one or more asset types;
ingest the asset data from the one or more data stores based at least in part on the one or more second user inputs that connect the asset data to the unified data model;
generate an asset service action training data set based at least in part on the ingested asset data; and
train the model to predict future asset service actions based at least in part on the asset service action training data set.

11. The apparatus of claim 10, wherein the one or more processors are individually or collectively further operable to execute the code to cause the apparatus to:
receive information associated with an asset service action for an asset type of the one or more asset types; and
provide, via the model for predict future asset service actions, one or more recommendations for one or more future asset service actions for the asset type based at least in part on training the model and the information.

12. The apparatus of claim 11, wherein, to provide one or more recommendations for one or more future asset service actions, the one or more processors are individually or collectively operable to execute the code to cause the apparatus to:
assign a relative likelihood score to each of the one or more future asset service actions based at least in part on training the model and the information.

13. The apparatus of claim 10, wherein, to ingest the asset data according to the unified data model, the one or more processors are individually or collectively operable to execute the code to cause the apparatus to:
generate one or more asset service action instances for each of the one or more asset types based at least in part on the unified data model, wherein each asset service action instance corresponds to an asset service action of the asset data, and wherein each asset service action instance comprises an asset type field, a service type field, and a service date field.

14. The apparatus of claim 13, wherein each asset service action instance further comprises a parent asset field, one or more product identifier fields, a start time field associated with the asset service action, an end time field associated with the asset service action, a date of asset installation field, a geographic location field, an asset service status field, one or more asset usage fields, or any combination thereof.

15. The apparatus of claim 10, wherein, to generate the asset service action training data set, the one or more processors are individually or collectively operable to execute the code to cause the apparatus to:
transform the ingested asset data into a plurality of entries, wherein each entry of the plurality of entries comprises an asset type field, an asset service action type field, a next asset service action type field, and a binary prediction field, wherein the model is trained based at least in part on the plurality of entries.

16. The apparatus of claim 10, wherein the one or more data stores include a first data store comprising a first data organization model and a second data store comprising a second data organization model different from the first data organization model.

17. The apparatus of claim 10, wherein, to receive the one or more second user inputs, the one or more processors are individually or collectively operable to execute the code to cause the apparatus to:
receive an indication that a data object of the one or more data stores is to be ingested as one or more predefined fields of the unified data model.

18. The apparatus of claim 10, wherein the one or more processors are individually or collectively further operable to execute the code to cause the apparatus to:
provide, in response to training the model, a second user interface that comprises one or more indications of one or more metrics associated with training the model.

19. A non-transitory computer-readable medium storing code for data processing, the code comprising instructions executable by one or more processors to:
receive first user input comprising a request to generate a model for predicting future asset service actions for one or more asset types;
receive, at a user interface, one or more second user inputs that connect asset data of one or more data stores to a unified data model associated with asset service action prediction, wherein the asset data indicates a history of previous service actions of the one or more asset types;
ingest the asset data from the one or more data stores based at least in part on the one or more second user inputs that connect the asset data to the unified data model;
generate an asset service action training data set based at least in part on the ingested asset data; and
train the model to predict future asset service actions based at least in part on the asset service action training data set.

20. The non-transitory computer-readable medium of claim 19, wherein the instructions are further executable by the one or more processors to:
receive information associated with an asset service action for an asset type of the one or more asset types; and
provide, via the model for predict future asset service actions, one or more recommendations for one or more future asset service actions for the asset type based at least in part on training the model and the information.
